(19) United States
(12) Patent Application Publication
(10) Pub. No.: US 2005/0008257 A1
(43) Pub. Date: Jan. 13, 2005

(54) Apparatus with thumbnail image data processing function and method for processing thumbnail image data

(76) Inventor: Satoru Tsukihara, Iwate-ken (JP)

Correspondence Address: BRINKS HOFER GILSON & LIONE, P.O. BOX 10395, CHICAGO, IL, 60610, US

(21) Appl. No.: 10/824,327

(22) Filed: Apr. 14, 2004

(30) Foreign Application Priority Data
Apr. 15, 2003 (JP) 2003-110622

(51) Int. Cl. G06K 9/32; G06K 9/36

(52) U.S. Cl. 382/293; 382/232

(57) ABSTRACT

An apparatus and method is provided that performs display and printing of thumbnail images. Thumbnail image data for display corresponding to a long shaped image has the same visible angle as a thumbnail image for display and printing of a wide shaped image. This permits the long shaped thumbnail image to be displayed and printed without a non-display portion. The thumbnail image data for printing corresponding to the thumbnail image for printing that have a different visible angle from a thumbnail image for displaying and printing 15 by 90° and do not have the non-display portion are stored in a memory.

### BACKGROUND OF THE INVENTION

1. Field of the Invention

The present invention relates to an apparatus with thumbnail image data processing function and a method for processing the thumbnail image data.

2. Description of the Related Art

In recent years, in addition to personal computers, a variety of apparatuses that are able to process image data, store digital image data and display them on display means have become widely used. Such apparatuses include digital still cameras, digital video cameras, printers, or the like.

Generally, such an apparatus is supposed to store image data of a rectangular shape having an aspect ratio of 3:4, and may store the image data of a rectangular shape having an aspect ratio of 4:3, which is rotated by 90° from the image data having the aspect ratio of 3:4.

When each of image data names is displayed on the display means of the apparatus and any one of the image data names is then designated, the image is supposed to be displayed based on the image data of the designated image data name. In a case of the digital still camera, the image is supposed to be displayed based on the stored order of the image data.

However, the image data has a large amount of data, and in particular color image data such as a photograph has a huge amount of data. Also, the number of pixels has increased in recent years, increasing the picture resolution and correspondingly increasing the amount of image data. Because of this, it takes a large amount of time to display an image based on the designated image data. In addition, when the image data is compressed and stored in a JPEG format, the apparatus must first expand the image data to display it, thereby substantially increasing the period of time before the image is displayed.

In the case of the personal computer, it is sometimes difficult to recognize the contents of the image using only the image data name, and the images are confirmed by displaying them one at a time to display the desired image, so that it takes a lot of time to display the desired image. In the case of the digital still camera, the image data is displayed based on the stored order thereof, so that it also takes a lot of time to display the desired image.

To cope with the above-mentioned problem, Japanese Unexamined Patent Application publication No. 2000-341572 discloses an apparatus that generates thumbnail image data having a small amount of data with a reduced number of pixels based on the image data, and stores each thumbnail image data together with the corresponding image data.

This apparatus first displays a plurality of thumbnail images on a display means using each stored thumbnail image data, and displays the image based on the image data corresponding to the designated thumbnail image when a thumbnail image among the displayed thumbnail image data is designated. As a result, a desired image is displayed much more quickly.

However, although image data is supposed to be accurately stored, the apparatus always forms thumbnail image data with a wide shape.

A wide shaped thumbnail image data is formed when a wide shaped image data is compressed in the width direction. A long shaped thumbnail image data, on the other hand, is formed when a long shaped image data is compressed and stored using a wide shape, resulting in a wide shaped thumbnail image that has non-display black portions at both ends thereof.

When the thumbnail image is displayed in a wide shaped thumbnail image data based on wide shaped image data, it can be displayed using a visible angle associated with the thumbnail image based on the wide shaped image data, so that it is preferable to display it by means of the thumbnail image data. However, when the thumbnail image is printed using the wide shaped thumbnail image data based on a long shaped image, both ends of the thumbnail image have non-display black portions that are printed, which results in a degraded print.

### SUMMARY OF THE INVENTION

The present invention is directed to an apparatus capable of processing image data and displaying and printing a good thumbnail image and a method for processing the image data.

One aspect of the present invention provides an apparatus capable of processing image data that comprises a compression unit, a memory, and a control unit. The compression unit compresses image data representing images having different shapes into thumbnail image data for display and printing of thumbnail images. The memory stores the thumbnail image data. The control unit permits display of thumbnail image data for displaying a thumbnail image of a first image having a first shape for displaying having a non-display portion and having the same visible angle as a thumbnail image corresponding to of a second image having a second shape, and permits printing of thumbnail image data of the first image for printing without the non-display portion and having a different visible angle from that of the thumbnail image of the second image.

In this aspect, the first image may be a wide shaped image and the second image may be a long shaped image. In this case, the thumbnail image printed for the long shaped image is rotated by 90° from the thumbnail image printed for the wide shaped image.

In another aspect of the present invention, a method for processing image data comprises displaying thumbnail images of first and second shapes that correspond to images of similar shapes using thumbnail image data for displaying such that the thumbnail images displayed have the same visible angle, and the thumbnail images of the first shape have a non-display portion while the thumbnail images of the second shape do not have a non-display portion. The method also comprises printing the thumbnail images of the first and second shapes using thumbnail image data for printing such that the thumbnail images displayed have different visible angles, and neither the thumbnail images of the first nor second shapes have the non-display portion.

The method as claim 3, may also comprise compressing data of the images into the thumbnail image data for both displaying and printing of the thumbnail images having the first shape and separate thumbnail image data for displaying and thumbnail image data for printing of thumbnail images having the second shape, and storing the image data, the thumbnail image data for displaying, and the thumbnail image data for printing such that the data are associated with one another.

In the second aspect, the first and second shaped images may correspond to a wide shaped image and a long shaped image, respectively, wide shaped thumbnail images may be formed by compressing the wide shaped images, and long shaped thumbnail images may be formed by compressing the long shaped images, long shaped thumbnail image data for displaying correspond to long shaped images having the same visible angle as the wide shaped thumbnail images, and long shaped thumbnail image data for printing correspond to long shaped thumbnail images having a visible angle 90° different from that of the wide thumbnail image.

### BRIEF DESCRIPTION OF THE DRAWINGS

FIG. 1 is a block diagram for showing one embodiment of an apparatus with image data processing function in accordance with the present invention;

FIG. 2 shows an exemplary wide shaped image formed by the apparatus with the image data processing function shown in FIG. 1;

FIG. 3 shows an exemplary long shaped image formed by the apparatus with the image data processing function shown in FIG. 1;

FIG. 4 shows a thumbnail image for displaying and printing corresponding to the wide shaped image of FIG. 2;

FIG. 5 shows a thumbnail image for displaying corresponding to the long shaped image of FIG. 3;

FIG. 6 shows a thumbnail image for printing corresponding to the long shaped image of FIG. 3;

FIG. 7 shows a flow chart for explaining a process of forming the image data for photographing an object and storing it in a memory 2 by means of the apparatus with the image data processing function of FIG. 1;

FIG. 8 shows a flow chart for explaining a process of transforming the wide shaped image data to the long shaped image data and storing it in a memory by means of the apparatus with the image data processing function of FIG. 1;

FIG. 9 shows a flow chart for explaining a process of displaying a thumbnail image corresponding to the long shaped image by means of the apparatus with the image data processing function of FIG. 1;

FIG. 10 shows a flow chart for explaining a process of printing a thumbnail image corresponding to the long shaped image by means of the apparatus with the image data processing function of FIG. 1;

FIG. 11 shows an exemplary thumbnail image displayed on display means of the apparatus with the image data processing function by means of the process of FIG. 9; and

FIG. 12 shows exemplary thumbnail images printed on a recording medium employing the process of FIG. 1.

### DESCRIPTION OF THE PREFERRED EMBODIMENT

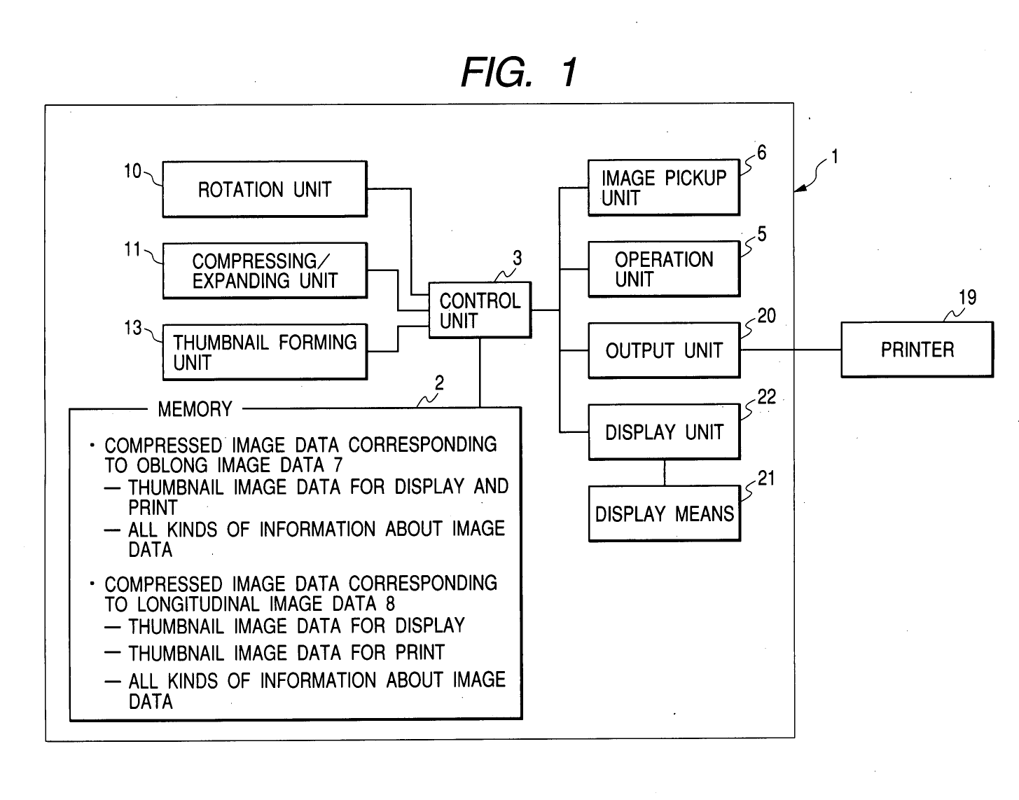

Hereinafter, embodiments of the apparatus with the image data processing function in accordance with the present invention will be described with reference to FIG. 1 to FIG. 6. In the present embodiments, a digital still camera that is able to process image data is described.

FIG. 1 is a block diagram of a schematic configuration of a digital still camera according to the present invention. As shown in FIG. 1, the digital still camera 1 comprises a control unit 3 for controlling operation of each component disposed in the digital still camera based on programs stored in a memory 2.

In addition, the digital still camera 1 comprises an operating unit 5 having a touch panel or switch for manipulating operation of each component of the digital still camera 1, and an image pickup unit 6 for photographing an object using lens such as a charge coupled device (CCD) or the like to form analog image data and convert the analog image data to digital image data.

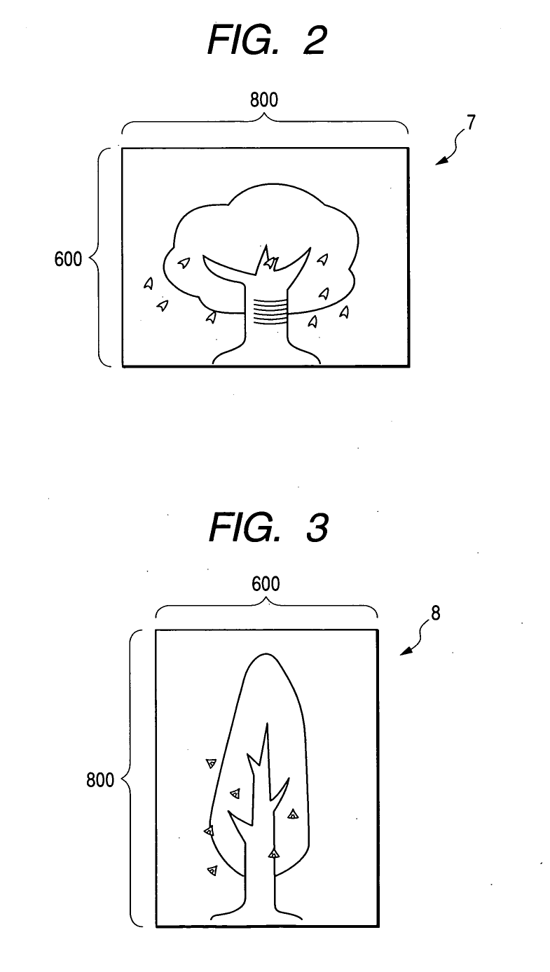

The image pickup unit 6 is in principle adapted to form image data corresponding to a wide shaped image 7 having an aspect ratio of 3:4 (for example, 600×800 pixels) as shown in FIG. 2. And the image pickup unit 6 may be adapted to form image data corresponding to a long shaped image 8 having an aspect ratio of 4:3 (for example, 800×600 pixels) as shown in FIG. 3 by detecting rotation of the digital still camera 1 or changing the image data forming direction set in the operating unit 5 when the digital still camera 1 is rotated by 90° to photograph the object.

Furthermore, the digital still camera 1 comprises a rotation unit 10 for rotating the wide shaped image 7 by 90° to create a long shaped image 8 based on the setting of the operating unit 5. And the digital still camera 1 comprises a compressing/expanding unit 11 for compressing the digital image data formed in the image pickup unit 6 to be stored in the memory 2 or for expanding the compressed image data to be displayed or printed.

In addition, the digital still camera 1 comprises a thumbnail forming unit 13 for forming a wide shaped thumbnail image data having an aspect ratio of 3:4 (for example, 120×160 pixels) by processing the digital image data formed in the image pickup unit 6 to have a low resolution of ¼, ⅙, ⅛, 1/12, 1/16, or 1/24 the resolution of the digital image data.

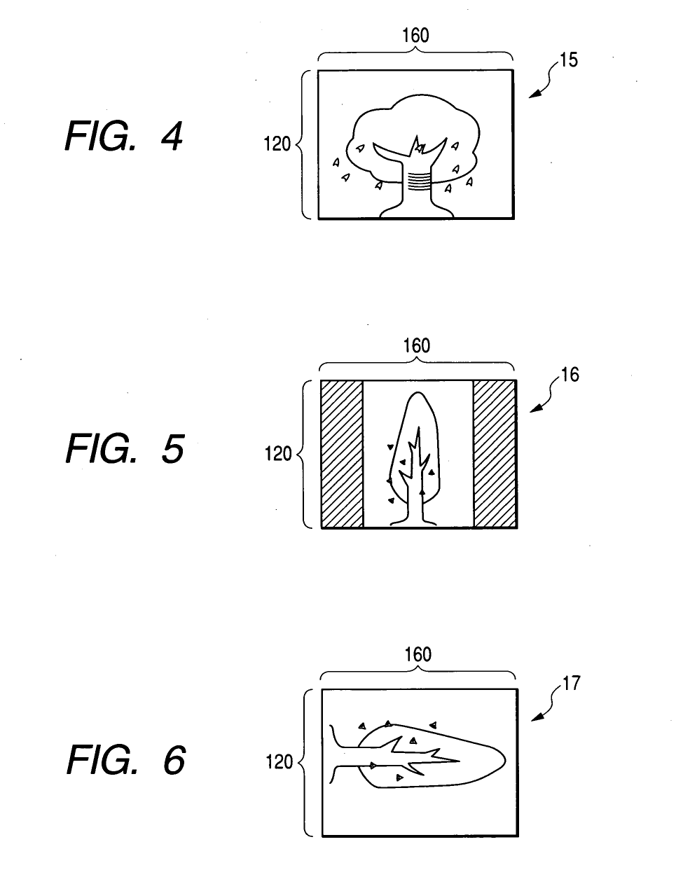

This thumbnail forming unit 13 is adapted to form thumbnail image data for displaying and printing of a thumbnail image 15 for displaying and printing corresponding to the wide shaped image 7 shown in FIG. 4 by reducing the wide shaped image data when the thumbnail image data corresponding to the wide shaped image 7 is formed. And the thumbnail forming unit 13 is also adapted to form the thumbnail image data for displaying the thumbnail image 16 for displaying shown in FIG. 5, which is reduced to be stored within a shape of the wide shaped thumbnail image to thereby have non-display black portions at both ends thereof when the thumbnail image data corresponding to the long shaped image 8 is formed. This thumbnail image for displaying 16 has the same visible angle (i.e. they are shown in the same direction) as the thumbnail image 15 for displaying and printing. The thumbnail forming unit 13 is also adapted to form the thumbnail image data for printing of the thumbnail image 17 for printing shown in FIG. 6, which does not have the non-display black portions by rotating the long shaped image data by 90° and then reducing it. This thumbnail image data for printing 17 is different from that of the thumbnail image 15 for displaying and printing 15 as the image is rotated90° .

The control unit 3 has the memory 2 store the compressed image data and the thumbnail image data for displaying and printing based on the wide shaped image data, and store the compressed image data and the thumbnail image data for displaying and the thumbnail image data for printing based on the long shaped image data.

The digital still camera 1 further comprises an output unit 20 for outputting each image data or each thumbnail image data through a wireless or wired connection to an external printer 19 so as to have each image or each thumbnail image printed, display means 21 comprised of a liquid crystal display, and a display unit 22 for displaying each image or each thumbnail image on the display means 21, which results from the each image data or each thumbnail image data. In addition, the display means 21 may have a touch panel in the operating unit 5.

Next, the method for processing the image data using the digital still camera 1 will be described.

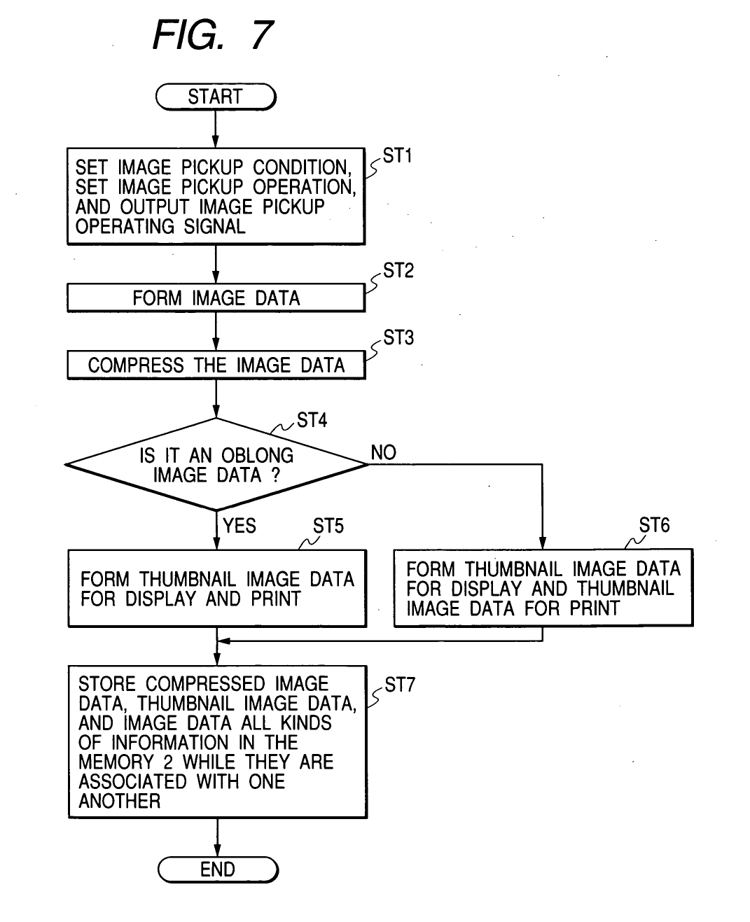

First, a process of photographing an object to form image data and storing it in the memory 2 will be described with reference to FIG. 7.

Resolution modes such as compression rate, the number of pixels, file size, etc... or photographic conditions such as an image quality mode are first set in the operating unit 5. The photographing switch is operated, so that the setting signal and the operating signal for photographing are output to the control unit 3 (ST1).

In more detail, the control unit 3 has the image pickup unit 6 photograph the object to form wide shaped or long shaped image data, and converts the analog image data to digital image data (ST2).

The control unit 3 then has the compressing and expanding unit 11 compress the digital image data based on the pickup conditions of the operating unit 5 to form the compressed image data.

The control unit 3 also forms thumbnail image data having a low resolution based on the digital image data in the thumbnail forming unit 13. In this case, the thumbnail forming unit 13 reduces the image data as it is to form the wide shaped thumbnail image data for displaying and printing (ST5), when the image data corresponds to image data of the wide shaped image 7 (i.e., Yes in ST4). And the thumbnail forming unit 13 forms the reduced thumbnail image data for displaying corresponding to the thumbnail image 16 for displaying, which has non-display black portions at both ends thereof to be stored within a shape of the wide shape image data, and forms the reduced thumbnail image data for printing as it is, which has been rotated by 90° from the long shaped image data (ST6) when the image data correspond to the image data representing the long shaped image 8 (No in ST4).

The control unit 3 stores various kinds of information including the compressed image data, thumbnail image data for displaying and printing, and the resolution mode of the image data in the memory 2 to be associated with one another when the formed image data correspond to the image data of the wide shaped image 7. In addition, when the formed image data correspond to the long shaped image 8, the control unit 3 stores various kinds of information including the compressed image data, thumbnail image data for displaying, thumbnail image data for printing, and the image data in the memory 2 to be associated with one another (ST7).

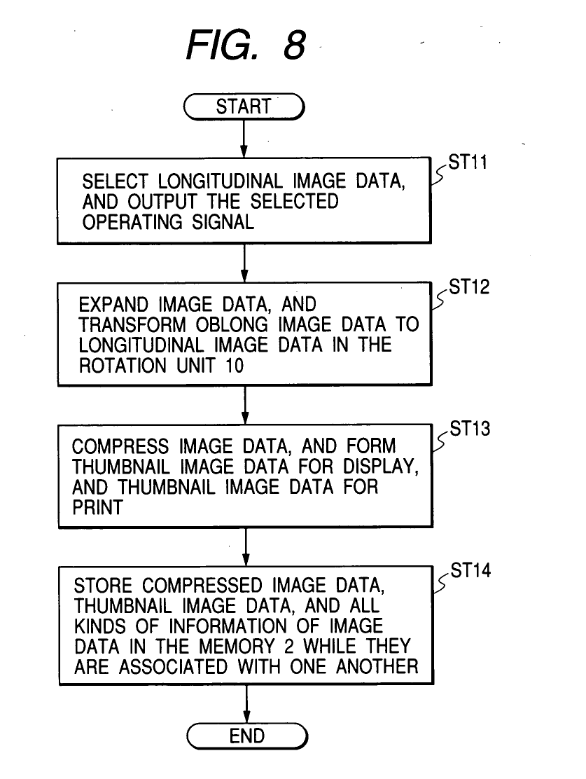

Next, a process of transforming the wide shaped image data to the long shaped image data and storing it in the memory 2 will be described with reference to FIG. 8.

The display means 21 displays each image or each thumbnail image based on the image data or thumbnail image data stored in the memory 2, and any image 7 to be transformed to the long shaped image 8 may be selected among wide shaped images 7 by means of the operating unit 5, and the selected operating signal is output to the control unit 3 (ST11).

As a result, the control unit 3 reads out the compressed image data corresponding to the image 7 selected in the memory 2 to expand the read out data in the compressing and expanding unit 11 and to transform the wide shaped image data to the long shaped image data in the rotating unit 10 (ST12).

And the control unit 3 compresses the long shaped image data in the compressing and expanding unit 11, and forms thumbnail image data for displaying and thumbnail image data for printing based on the long shaped image data in the thumbnail forming unit 13 (ST13).

The control unit 3 then stores various information including the compressed image data, thumbnail image data for displaying, thumbnail image data for printing, and the image data based on the long shaped image data in the memory 2 to be associated with one another. In this case, information including the thumbnail image data for displaying and printing and the image data, which have been stored in the memory to be associated with the compressed image data based on the wide shaped image data that are not transformed, are replaced with new information including the transformed thumbnail image data and image data. Alternatively, if the thumbnail image data for displaying and printing corresponding to the wide shaped image data before transformation and the thumbnail image data for printing corresponding to the long shaped image data after transformation are the same, in addition to the case in which information of the image data before transformation is same as that of the image data after transformation, the information before transformation may be used rather than being replaced by the information after transformation.

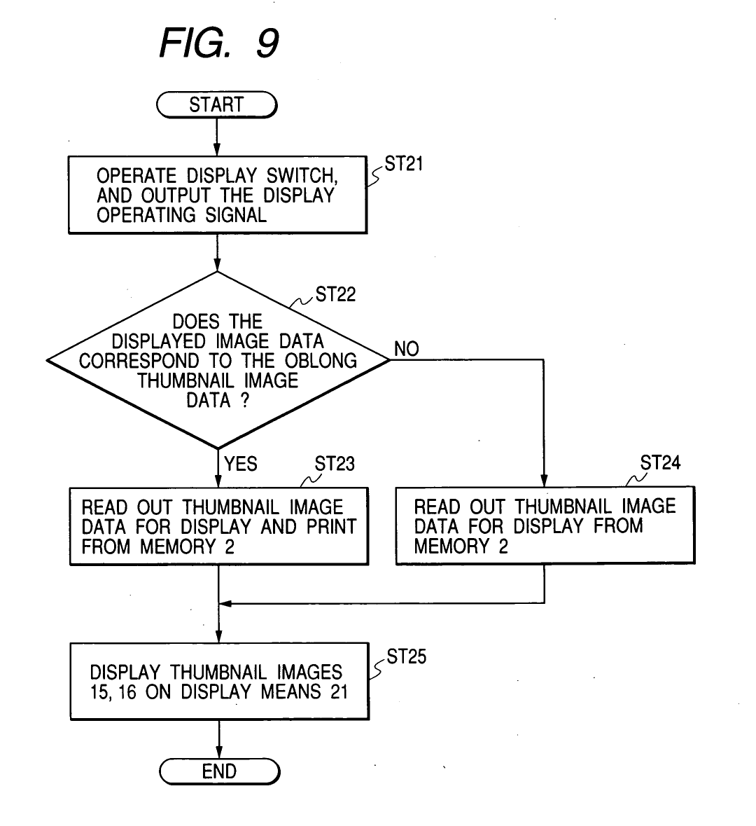

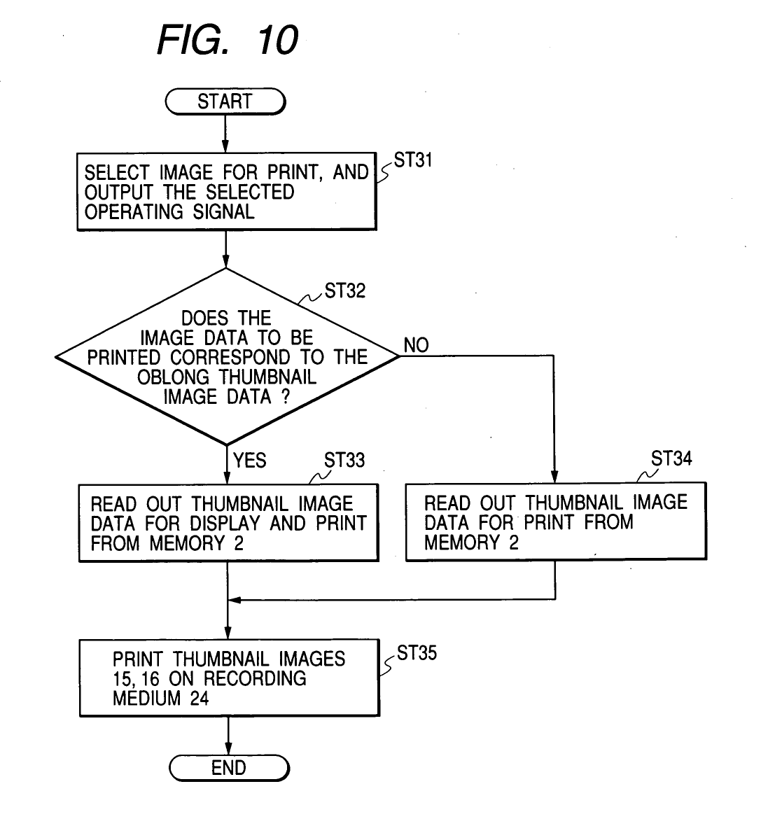

Next, a process of displaying or printing thumbnail image corresponding to the long shaped image will be described with reference to FIG. 9 and FIG. 10.

As shown in FIG. 9, the display switch is operated by the operating unit 5 to display the thumbnail image, and the operating signal for the display is output to the control unit 3 (ST21). In this case, when each thumbnail image is displayed on the display means 21, the number of thumbnail images to be displayed can be set by the operating unit 5.

In response to the above setting, the control unit 3 reads out the thumbnail image data that has been set from the memory 2 based on a predetermined order such as the photographed order. In this case, the control unit 3 reads out thumbnail image data for displaying and printing to output to the display unit (ST23) when thumbnail image corresponding to the wide shaped image data is displayed (i.e., Yes in ST22), and reads out thumbnail image data for displaying to output to the display unit (ST24) when thumbnail image corresponding to the long shaped image data is displayed (No in ST22).

The display unit 22 transforms each of the thumbnail image data for displaying and printing and each of the thumbnail image data for displaying to analog images, and displays each of thumbnail images 15 and 16 on the display means 21 based on the wide and long shaped image data as shown in FIG. 10 (ST25).

When the thumbnail image is printed, as shown in FIG. 10, each of the thumbnail image displayed on the display means 21 is referred to, and at least one of thumbnail images to be printed is then selected in the operating unit 5, and the selected operating signal is output to the control unit 3 (ST31).

As a result, the control unit 3 reads out thumbnail image data for displaying and printing (ST33) when the thumbnail image corresponding to the wide shaped image data is printed (Yes in ST32), and reads out thumbnail image data for printing (ST34) when the thumbnail image corresponding to the long shaped image data is displayed (No in ST32), and the control unit 3 then outputs the thumbnail image data to the output unit 20.

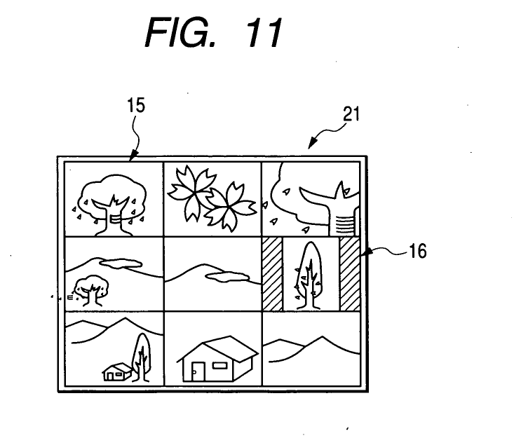

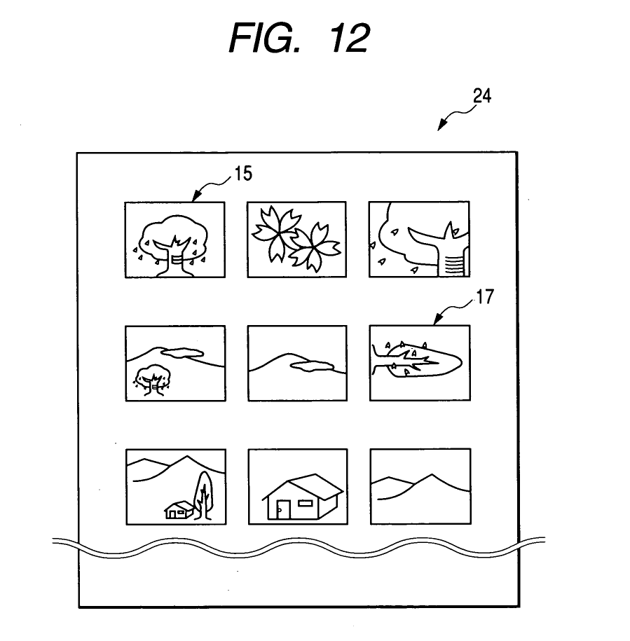

The output unit 20 outputs each of the thumbnail image data for displaying and printing and each of the thumbnail image data for printing to the printer 19 through a wireless or wired connection, and the printer 19 prints each of the thumbnail images 15 and 17 based on the wide and long shaped image data as shown in FIG. 11 (ST35).

As mentioned above, in accordance with the present embodiment, each of the thumbnail image data for displaying and each of the thumbnail image data for printing are stored in the memory 2 of the digital still camera 1 to be associated with the compressed image data corresponding to the long shaped image 8. And the digital still camera 1 uses thumbnail image data for displaying to perform display the thumbnail image 16 corresponding to the long shaped image 8, so that it can display the thumbnail image 16 with the same visible angle as the thumbnail image 15 corresponding to the wide shaped image 7. In addition, the digital still camera 1 uses thumbnail image data for printing to print the thumbnail image 17 corresponding to the long shaped image 8, so that it can be prevented from having non-display black portions at both ends of the printed thumbnail image 17, and a thumbnail image 17 having the same size as the thumbnail image 15 corresponding to the wide shaped image 7 can be printed.

In accordance with the digital still camera 1 of the present embodiment, thumbnail image for displaying 16 corresponding to the long shaped image 8 and thumbnail image for displaying and printing 15 corresponding to the wide shaped image 7 can be visible with the same visible angle in the display means 21, so that a better display can be performed. In addition, the thumbnail image for printing 17 corresponding to the long shaped image 8 can be printed without non-display black portions on the recording medium 24, so that the thumbnail image for printing 17 can be better printed.

Alternatively, the present invention is not limited to the above embodiment, and may be modified if necessary.

For example, as means for obtaining the long shaped image data, the long shaped image data are formed in the pickup unit 6, and the rotating unit 10 rotates the wide shaped image data to long shaped image data in the present embodiment, however, the present invention is not limited thereto, and may have means for obtaining any one of the long shaped image data, and may have another means for obtaining the long shaped image data.

In addition, the function of the operating unit 5 of the digital still camera 1 is not limited to the present embodiment.

Furthermore, the present embodiment has described the digital still camera 1 for the apparatus with image data processing function, however, is not limited to this digital still camera. For example, the present invention may be applied to a digital video camera, or to an apparatus that forms the thumbnail image data based on the input image data for the personal computer or printer.

As mentioned above, according to the apparatus of the present invention that processes image data, a thumbnail image for display corresponding to one shaped image and a thumbnail image corresponding to another shaped image may be visible with the same visible angle, so that a good display may be obtained in a display means. In addition, a thumbnail image for printing corresponding to another shaped image may be printed without any non-display portion being printed in a recording medium, so that a good thumbnail image for printing may be printed.

In addition, according to the apparatus with image data processing function of the present invention, a thumbnail image for display corresponding to a long shaped image and a thumbnail image for display and printing corresponding to a wide shaped image may be visible with the same visible angle, so that a good display may be obtained in the display means. And in a recording medium, the thumbnail image for printing corresponding to the long shaped image may be printed without any non-display portion, so that a good thumbnail image for printing may be printed.

Furthermore, according to one method for processing image data of the present invention, a thumbnail image for display corresponding to one shaped image and a thumbnail image corresponding to another shaped image may be visible with the same visible angle, so that a good display may be obtained in display means. In addition, a thumbnail image for printing corresponding to another shaped image may be printed without any non-display portion in a recording medium, so that a good thumbnail image for printing may be printed in a recording medium.

Furthermore, according to other method for processing image data of the present invention, a thumbnail image for display corresponding to a long shaped image and a thumbnail image for display and printing corresponding to a wide shaped image may be visible with the same visible angle, so that a good display may be obtained in display means. In addition, a thumbnail image for printing corresponding to the long shaped image may be printed without any non-display portion in a recording medium, so that a good thumbnail image for printing may be printed in a recording medium.

1. An apparatus able to process data, the apparatus comprising:
a compression unit that compresses image data representing images having different shapes into thumbnail image data for display and printing of thumbnail images;
a memory that stores the thumbnail image data; and
a control unit that permits display of thumbnail image data for displaying a thumbnail image of a first image having a first shape for displaying having a non-display portion and having the same visible angle as a thumbnail image corresponding to of a second image having a second shape, and permits printing of thumbnail image data of the first image for printing without the non-display portion and having a different visible angle from that of the thumbnail image of the second image.

2. The apparatus of claim 1, wherein the first image is a wide shaped image and the second image is a long shaped image, and the thumbnail image printed for the long shaped image is rotated by 90° from the thumbnail image printed for the wide shaped image.

3. A method for processing image data comprising:
displaying thumbnail images of first and second shapes that correspond to images of similar shapes using thumbnail image data for displaying such that the thumbnail images displayed have the same visible angle, and the thumbnail images of the first shape have a non-display portion while the thumbnail images of the second shape do not have a non-display portion, and
printing the thumbnail images of the first and second shapes using thumbnail image data for printing such that the thumbnail images displayed have different visible angles, and neither the thumbnail images of the first nor second shapes have the non-display portion.

4. The method of claim 3, further comprising:
compressing data of the images into the thumbnail image data for both displaying and printing of the thumbnail images having the first shape and separate thumbnail image data for displaying and thumbnail image data for printing of thumbnail images having the second shape, and
storing the image data, the thumbnail image data for displaying, and the thumbnail image data for printing such that the data are associated with one another.

5. The method of claim 3, wherein the first and second shaped images correspond to a wide shaped image and a long shaped image, respectively, wide shaped thumbnail images are formed by compressing the wide shaped images, and long shaped thumbnail images are formed by compressing the long shaped images, long shaped thumbnail image data for displaying correspond to long shaped images having the same visible angle as the wide shaped thumbnail images, and long shaped thumbnail image data for printing correspond to long shaped thumbnail images having a visible angle 90° different from that of the wide thumbnail image.
